(19) United States
(12) Patent Application Publication
(10) Pub. No.: US 2006/0166719 A1
(43) Pub. Date: Jul. 27, 2006

(54) Mobile device multi-antenna system

(75) Inventors: Oren Arad, Palo Alto, CA (US); Gregory Francis Johnson, Aptos, CA (US)

Correspondence Address: CARR & FERRELL LLP, 2200 GENG ROAD, PALO ALTO, CA, 94303, US

(73) Assignee: SiPort, Inc.

(21) Appl. No.: 11/339,074

(22) Filed: Jan. 24, 2006

Related U.S. Application Data
(60) Provisional application No. 60/646,557, filed on Jan. 25, 2005.

(51) Int. Cl. H04M 1/00

(52) U.S. Cl. 455/575.2

(57) ABSTRACT

Systems for improving radio reception on a mobile device are provided. In exemplary embodiments, the system comprises a headset apparatus having a plurality of antenna elements. In exemplary embodiments, the plurality of antenna elements may be positioned in such a manner as to result in low-correlation between the plurality of antenna elements. For example, at least one of the antenna elements may be vertically oriented near a plug of the headset apparatus. Further antenna elements may be oriented vertically, horizontally, or both near an earpiece of the headset apparatus or above a juncture where a left and right cord of the headset apparatus splits. Exemplary embodiments may also comprise a receiving device configured to receive RF signals from the plurality of antenna elements and process these signals for playback on the headset apparatus.

### CROSS-REFERENCE TO RELATED APPLICATION

This application claims the priority benefit of U.S. Provisional Patent Application Ser. No. 60/646,557, filed Jan. 25, 2005, entitled “Headphone apparatus coupled with two antenna used by receiver apparatus,” which is incorporated herein by reference.

### BACKGROUND OF THE INVENTION

1. Field of the Invention

The present invention relates generally to antennas, and more particularly to utilizing antenna elements in a headset apparatus.

2. Description of Related Art

Presently, wireless digital communication systems are widely used in multiple applications, in both fixed and mobile devices. Electromagnetic (EM) waves used in wireless transmission, however, experience interferences caused by diffraction, refraction, and reflections of the EM waves. Constrictive and destructive interferences create variation in signal power at a receiver. The received signal power varies as a function of time, frequency, and spatial location. Additionally, the received signal power may occasionally fade below a certain decodable threshold, where the receiver no longer is able to decode the transmitted data reliably, resulting in data errors.

An effective way of improving wireless system performance (e.g., reducing bit error rate) is by using multiple (receive) antennas, where the receiver can interface and process the signal coming from the multiple antennas. The antennas are positioned in space such that each antenna perceives different instantiations of the EM waves. In other words, the received signals from the different antennas are uncorrelated or have low correlation. As a result, fading patterns of the EM waves in each antenna will be different. Therefore, a probability that the signal power will fall below the decodable threshold at all of the antennas at the same time and at a same frequency is much lower than for a case of a single antenna. The receiver can therefore use information from the different antennas to reduce probability of error.

Conventional methods for implementing a receiver that can take advantage of multiple uncorrelated antennas include weighing and combining the signal inputs or selecting between different inputs. The gain achieved by these methods is called antenna diversity gain.

A key requirement for providing significant diversity gain from multiple antennas is that the antenna elements should be uncorrelated or have low correlation between them. This can be achieved by positioning the antennas a certain distance from one another. Such distance should typically be more then one half of the EM wavelength (of the lowest received frequency of interest). Another method of achieving low correlation between two antennas is to dispose the antennas with orthogonal polarization. Thus, in one example, one antenna element will have a horizontal polarization, while a second antenna element will have a vertical polarization. Use of a combination of spatial separation and different orientation can ensure low correlation between two antenna elements.

Mobile wireless devices such as cell phones, PDAs, and portable audio devices, which receive wireless transmissions, are susceptible to fading. Such mobile wireless devices can benefit from antenna diversity. The form and size of these devices, however, are very important for product acceptance by users. That is, users want small, lightweight mobile wireless devices. As such, attaching large antenna elements may not be acceptable or possible. This can prevent manufacturers from being able to provide a plurality of antenna elements that are sufficiently uncorrelated for substantial diversity gain.

Furthermore, an application of mobile wireless devices is to provide audio or video accompanied with audio to the user. The audio or video can be transmitted to the mobile wireless device via terrestrial or satellite broadcasting. The broadcast signal can be either an analog modulated signal or digitally modulated signal. Examples of analog broadcast signals are analog radio (e.g., FM and AM) and analog terrestrial TV (e.g., NTSC or PAL). Examples of digital broadcast signals include, but are not limited to, DVB-T, DVB-H, DAB, NRSC-5 ISDB-T and DMB. Many of these transmissions are in the VHF and UHF spectrum band. A common practice for implementing an antenna for portable devices receiving audio from transmission in the VHF/UHF band is to use a headphone cord as a single antenna element. This system, however, cannot benefit from multi-antenna diversity.

Therefore, there is a need for multi-antenna diversity in mobile devices to improve reliability of digital transmission decoding or analog transmission reception. There is a further need to provide multiple antenna elements for the mobile devices in a way that is convenient for the user and does not changes dimensions and use of the mobile device.

### SUMMARY OF THE INVENTION

Embodiments of the present inventions provide systems that utilize a plurality of antenna elements to improve radio reception. In exemplary embodiments of the present invention, a stereophonic headset apparatus provides stereophonic audio to the user, and provides a plurality of RF signals to a coupled receiver device simultaneously. In one embodiment, the stereophonic headset apparatus comprises two antenna elements, where the antenna elements are positioned in a way that greatly reduces the correlation of EM signals received by the two antennas. This enables improved reception by the radio receiver device. For example, a first antenna element may be coupled to an antenna cord in proximity to a plug. A second antenna element may be coupled to a support shaft between the left and right earpieces, or to a conducting cord between the left and right earpieces.

The exemplary headset apparatus is coupled to the mobile receiver device by two conducting cords which terminate in a plug having three conductors. The plug can be inserted into a corresponding jack in the receiver device to create electrical contacts between three conductors in the plug to three conductors of the jack.

The exemplary receiving device demodulates a plurality of RF signals signal received from the headset apparatus, and processes the RF signals in order to provide stereophonic or monophonic audio, or video coupled with audio to the headset apparatus. The exemplary receiver device comprises an RF part and a signal processing part. In one embodiment, the receiver device processes two RF signals received by two antenna elements in the headset apparatus to improve reception and to provide improved audio signals to the headset apparatus.

In one embodiment, the receiver device also includes a jack having three conductors. A first conductor carrying a left audio signal is coupled by an inductor to the first conductor in the plug. A second conductor carrying a right audio signal is coupled by a second inductor to the second conductor in the plug. The first conductor in the jack is also coupled by a capacitor to a conductor bus carrying the received RF signal from a first antenna element to the receiver device. The second conductor in the jack is also coupled by a second capacitor to a second conductor bus carrying the received RF signal from a second antenna element to the receiver device. A third conductor is coupled to the third conductor in the plug, and provides a common negative potential.

### BRIEF DESCRIPTION OF THE DRAWINGS

FIG. 1 is a diagram of an exemplary radio receiver device coupled to an exemplary headset apparatus;

FIG. 2 is a diagram of the exemplary radio receiver device

FIG. 3a-FIG. 3c are diagrams of the exemplary headset apparatus; and

FIG. 4. is a diagram of an alternative embodiment of a headset apparatus;

FIG. 5 is a diagram of an exemplary headset apparatus having a radiating antenna element;

FIG. 6 is a diagram of a headset apparatus with vertically oriented, radiating antenna elements;

FIG. 7a-FIG. 7b are diagrams of an alternative headset apparatus having a radiating antenna element;

FIG. 8 are diagrams of a headset apparatus having a plurality of antenna elements positioned near a plug;

FIG. 9 is a diagram of a headset apparatus comprising a meander-line ground wire; and

FIG. 10a-FIG. 10c are diagrams of further embodiments of a headset apparatus having a plurality of antenna elements.

### DESCRIPTION OF EXEMPLARY EMBODIMENTS

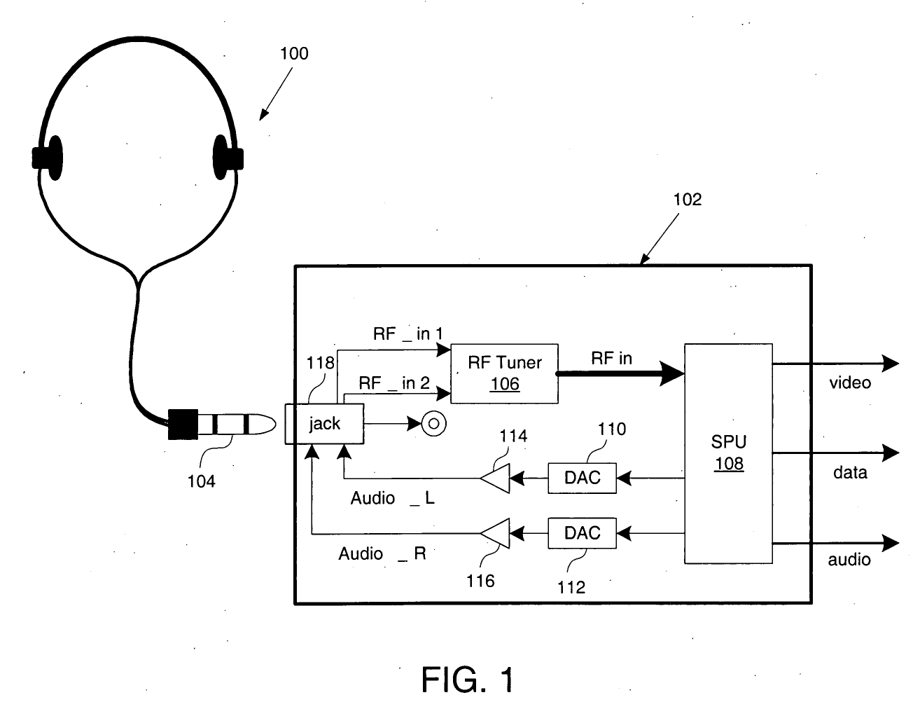

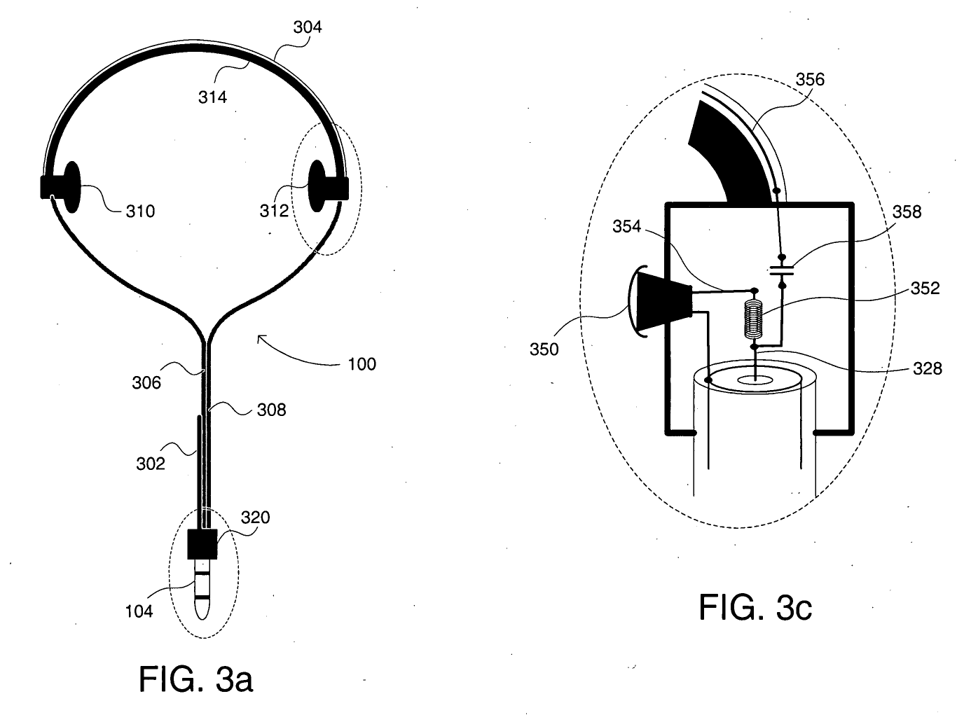

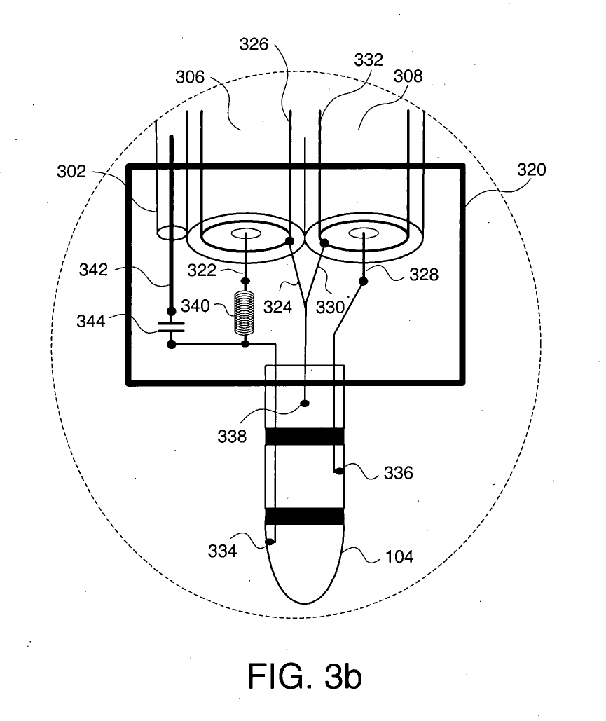

Embodiments of the present invention provide headsets having a plurality of antenna elements. In order to take advantage of spatial or polarization diversity, exemplary embodiments of the present invention coupled the antenna elements in such a manner as to result in low-correlation between the antenna elements. In one embodiment, two uncorrelated or low-correlated antenna elements are provided, although any number of antenna elements may be utilized in alternative embodiments. Referring to FIG. 1, an exemplary headset apparatus 100 and receiving device 102 are shown. The exemplary headset apparatus 100 may be a stereophonic headphone. The headset apparatus 100 may be coupled to, and interfaced with, the receiving device 102 via a plug or connector 104. The headset apparatus 100 will be discussed in more detail in connection with FIG. 3 below.

In exemplary embodiments, the receiving device 102 is a mobile, radio-receiving device which comprises a radio frequency (RF) tuner 106 configured to receive RF signals from one or more antenna elements of the headset apparatus 100. The RF tuner 106 selects a desired channel signal from an electromagnetic (EM) frequency spectrum and down converts the channel signal to an intermediate frequency (IF) signal or to direct current (DC) such that the channel signal can be processed by a signal processor unit (SPU) 108.

The RF tuner 106 may comprise a plurality of demodulation circuitries. In one embodiment of the present invention, two demodulation circuitries are provided. The demodulation circuitries are configured to select a signal on a particular channel and down convert the channel signal to an IF signal or direct current. In the present embodiment, the RF tuner 106 provides two IF real signals or two pairs of in-phase and quadrature signals to the SPU 108. Each of these signals originates from a different receiving antenna element as will be described in more detail in FIG. 3.

In an alternative embodiment, the RF tuner 106 comprises only a single demodulation circuitry configured to select the channel signal and down convert the channel signal to an IF signal or direct current. This embodiment of the RF tuner 106 further comprises a switch circuitry configured to select one of the antenna element's output (e.g., one of two antenna element's output). Thus, in this embodiment, the RF tuner 106 provides one IF signal or one pair of in-phase and quadrature signals to the SPU 108, whereby the signal originates from the antenna element selected by the switch circuitry.

The exemplary SPU 108 receives the down converted signal from the RF tuner 106 and demodulates the signal to produce a stream of data (e.g., audio signal, video signal, digital data, or a combination of some or all of these streams). In exemplary embodiments, the SPU 108 takes advantage of signals coming from two separate antenna elements by applying known diversity algorithms and utilizing polarization diversity. Spatial or polarization diversity comprises the use of at least two antenna elements with different polarization characteristics and different spatial positioning in a radio receiving system so as to produce two or more receive paths with substantially uncorrelated fading characteristics. By using information from two or more antenna elements, the SPU 108 can significantly improve quality of the demodulation. This may result in improved audio quality, improved video quality, and reduced bit error rate in data stream output.

The exemplary SPU 108 decodes the RF signal to produce a stereophonic audio signal or monophonic digital audio signal. In one example, the audio signal comprises a left digital stream and a right digital stream. These left and right digital audio streams may be converted to analog signals by digital to analog converters (DAC) 110 and 112, respectively. The resulting left and right analog signals are amplified by amplifiers 114 and 116, respectively, to produce an electric signal suitable to provide audio signals to the headset apparatus 100. In exemplary embodiments, the amplified audio signals comprise a left audio (audio_L) signal and a right audio (audio_R) signal. The amplified audio signals are provided to the headset apparatus 100 via a jack 118.

The jack 118 is configured to accept, and interface with, the plug 104 of the headset apparatus 100, thus interfacing the receiving device 102 and the headset apparatus 100. Functionally, the jack 118 interfaces with the plug 104 of the headset apparatus 100 to provide the audio_L signal and the audio_R signal from the receiving device 102 to the headset apparatus 100. The audio signal frequency may comprise any frequency. In exemplary embodiments, the frequencies are in a low frequency band range (e.g., 50 Hz to 25 KKz).

Simultaneous with transmitting the audio signals, the jack 118 receives RF signals from antenna elements in the headset apparatus 100 and forwards these RF signals to the RF tuner 106 for processing. In exemplary embodiments, the received RF signal frequency is in a frequency band above 30 MHz. Alternative embodiments may comprise other frequencies. Thus, the exemplary jack 118 is configured to take advantage of frequency separation between the audio and the RF signals in order to provide both signals at the same time.

The exemplary receiving device 102 is any receiver capable of receiving RF signals to produce audio, video, and/or data streams. In one embodiment, the receiving device 102 is a stand-alone device (e.g., a portable audio/video player). In this embodiment, all of the receiving functionalities and the user interface functionalities are implemented in the receiving device 102.

In an alternative embodiment, the receiving device 102 is a part of an integrated device, wherein the receiving device 102 provides the receiving functionalities and audio, video, and/or data output. The remainder of the integrated device provides other user interface functionalities such as video display, data storage, or audio output to speakers. Examples of such integrated devices include cellular phones, personal digital assistants (PDA), or personal computers.

Additionally, the exemplary receiver device 102 is configured to receive and demodulate one or more of the following signals: DAB, DVB-T, DVB-H, ISDB-T, DMB, NRSC-5, XM radio, Sirius radio, DTV, analog terrestrial TV, analog FM radio, or other transmitted signals providing audio, video, or data. Embodiments of the present invention may be practiced on all such transmissions which reside above a transmission frequency of 30 MHz. Alternative embodiments may be applicable to other frequencies.

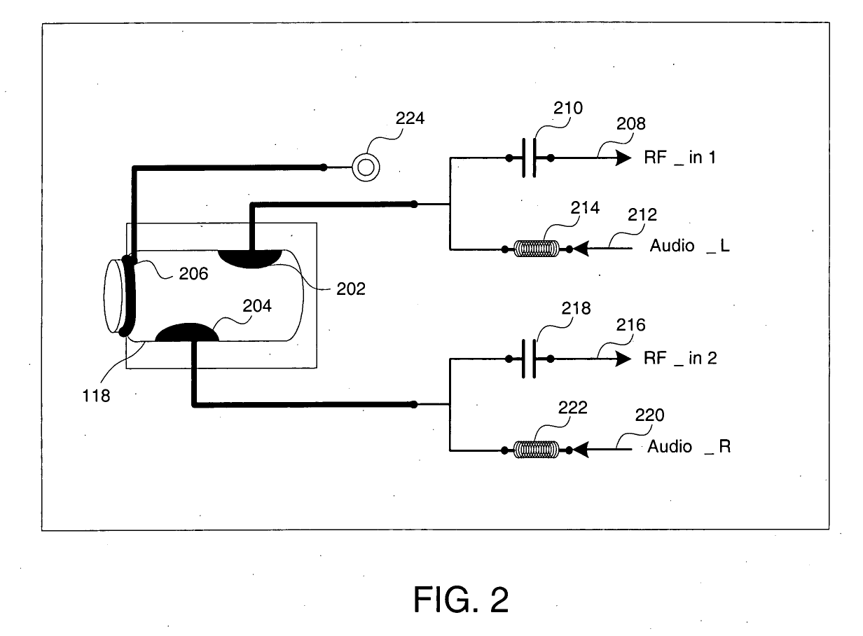

Referring now to FIG. 2, electrical connectivity of the exemplary jack 118 of the receiving device 102 (FIG. 1) is shown in more detail. The jack 118 comprises a plurality of electric conductors which create electrical connections with the plug 104 (FIG. 1) of the headset apparatus 100. In the embodiment shown, the jack comprises three electric conductors 202, 204, and 206.

In exemplary embodiments, the conductor 202 is coupled to a RF_in 1 bus 208 via a coupling capacitor 210. The coupling capacitor 210 transfers high RF signal frequencies received from a first antenna element of the headset apparatus 100 to the RF tuner 106 (FIG. 1). The capacitor 210 acts as a high pass filter. This coupling capacitor 210, however, does not allow low frequency audio_L signal from going to the RF tuner 106, which prevents overloading of the RF tuner 106 circuitry. In another embodiment, the high pass filter can have a different implementation to provide rejection of the audio signal.

The exemplary conductor 202 is also coupled to an audio_L bus 212 via a coupling inductor 214. The coupling inductor 214 transfers the low frequency audio_L signal from the amplifier 114 (FIG. 1) through the conductor 202 to a left earpiece of the headset apparatus 100. The coupling inductor 214 acts as a low pass filter. The coupling inductor 214 also prevents the high frequency RF signal RF_in 1 from going to the amplifier 114, which prevents loss of RF signal power. In another embodiment, the low pass filter can have a different implementation or can be completely omitted.

Similarly, conductor 204 is coupled to a RF_in 2 bus 216 via a coupling capacitor 218. The coupling capacitor 218 transfers high RF signal frequencies received from a second antenna element of the headset apparatus 100 to the RF tuner 106. The coupling capacitor 218 also prevents the low frequency audio_R signal from going to the RF tuner 106, thus protecting the RF 106 tuner circuitry from overloading.

Conductor 204 is also coupled to an audio_R bus 220 via a coupling inductor 222. The coupling inductor 222 transfers low frequency audio_R signal from the amplifier 116 (FIG. 1) through the conductor 204 to a right earpiece of the headset apparatus 100. The coupling inductor 222 further prevents the high frequency RF signal RF_in 2 from going to the amplifier 116 which prevents loss of RF signal power.

The conductor 206 is coupled to a common negative potential connector 224. In exemplary embodiments, the negative potential connector 224 is located on a printed circuit board of the receiving device 102 (FIG. 1). This negative potential connector 224 provides a common negate potential terminal to the earpieces of the headset apparatus 100 and provides shielding of the headset apparatus 100 cord or cords.

It should be noted that RF_in 1 and RF_in 2 are interchangeable, without affecting the functionalities of embodiments of the present invention. Furthermore, RF_in 1 or RF_in 2 may be coupled to the common conductor 206 via a coupling capacitor without affecting the functionality of embodiments of the present invention. It should be further noted that audio_L and audio_R are typically not interchangeable and are thus coupled to the appropriate conductors 202 and 204 in order to provide the left audio to the left earpiece and the right audio to the right earpiece.

Referring now to FIG. 3a, the exemplary headset apparatus 100 is shown in more detail. In exemplary embodiments of the present invention, the headset apparatus 100 comprises a plurality of antenna elements. In the present embodiment, there are two antenna elements 302 and 304. The headset apparatus 100 also comprises a left cord 306 and a right cord 308 coupled to a left earpiece 310 and a right earpiece 312, respectively. In the present embodiment, the first antenna element 302 is coupled to one of the cords 306 or 308, while the second antenna element 304 is coupled to a headpiece of the headset apparatus 100. Alternatively, the antenna elements 302 and 304 may be coupled to, or embedded within, various other parts of the headset apparatus 100.

The headset apparatus 100 may also include an optional support shaft 314. In one embodiment, the support shaft 314 comprises an elastic or ridged arched shaft. The exemplary support shaft 314 holds each of the earpieces 310 and 312 at a desired distance from each other, and supports these earpieces 310 and 312 on a user's head. While the support shaft 314 is shown positioned to remain on the user's head, alternatively, the support shaft 314 may be located behind the user's head (e.g., across a back of the head or neck).

Referring now to FIG. 3b, a detailed diagram of a plug assembly 320 comprising the plug 104 coupling with the cords 306 and 308 and the first antenna element 304 is shown. The left cord 306 comprises two conducting leads 322 and 324 and a conductive shield 326 surrounding the conductive lead 322. The conductive lead 322 and the conductive shield 326 may be isolated from one another by an insulating material. Similarly, the right cord 308 may comprise two conducting leads 328 and 330 and a conductive shield 332 surrounding the conductive lead 330 with an insulating material therebetween.

In an alternative embodiment, the left cord 306 comprises two conducting threads (in the location of the conductive leads 322 and 324) isolated from each other by an insulating material. Similarly, the right cord 308 comprises two conducting threads (in the location of the conductive leads 328 and 330) isolated from each other by an insulating material. The conducting threads (i.e., conductive leads without shields) are coupled to the rest of the headset apparatus 100 in a similar manner as the coaxial cord implementation (i.e., left cord 306 and right cord 308 implementations).

FIG. 3b also shows the plug 104 comprising three conducting elements 334, 336, and 338. When the plug 104 is inserted into the jack 118 (FIG. 2), the conducting elements 334, 336, and 338 electronically couple with the electrical conductors 202, 204, and 206, respectively. The conducting element 338 is coupled to both conductive shields 326 and 332, and provides a common negative reference potential to the conductive shields 326 and 332 via coupling with the common negative potential connector 224 (FIG. 2). In a further embodiment, the conducting element 338 may be coupled to a third antenna element (not shown). While three conducting elements are shown in the present embodiment, alternative embodiments may comprise any number of conducting elements, so long as the number of conducting elements corresponds with a same number of electrical conductors in the jack 118.

The conducting element 334 is coupled to the conductive lead 322 via a coupling passive component 340. In exemplary embodiments, the passive component 340 is an inductor. The exemplary passive component 340 is configured to transfer low frequency left audio signals from the receiving device 102 (FIG. 1) through the conductive lead 322 to the left earpiece 310 (FIG. 3a). The passive component 340 also prevents high frequency RF signals from the first antenna element 302 from transferring to the conductive lead 322. As such, the passive component 340 prevents loss of power of the RF signal coming from the first antenna element 302.

Additionally, the conducting element 334 is coupled to a conductive element 342 via a coupling passive component 344. In exemplary embodiments, the passive component 344 is a capacitor. This passive component 344 allows transfer of high RF signals obtained from the conductive element 342 to the receiving device 102. These high RF signals may be obtained from the air. The passive component 344 also prevents the low frequency audio_L signal from going to the conductive element 342. In an alternative embodiment, the passive components 340 and 344 are omitted and the first antenna element 302 is an extension of the conductive lead 322.

The exemplary conductive element 336 is coupled to the conductive lead 328. The conductive element 336 transfers audio_R signals from the receiving device 102 to the right earpiece 312 (FIG. 3). The conductor element 336 also receives RF signals from the second antenna element 304.

While the first antenna element 302 is shown coupled to the left cord 306, the first antenna element 302 may be mounted or coupled to the right cord 308 or between the two cords 306 and 308. In exemplary embodiments, the first antenna element 302 comprises a tubular insulator surrounding the conductive element 342.

In one embodiment, the length of the conductive element 342 is chosen to be one quarter of the wavelength of the RF signal of interest (i.e., the frequency carrying the received RF channel). In a case where a range of frequencies is of interest, the length of the conductive element 342 can be set to one quarter of the frequency which resides in a middle of the range. For example, a receiving device 102 designed to receive DAB signals in VHF3 band in a range of 174 MHz to 240 MHz may comprise a conductive element 342 with a length of 37.5 centimeters (i.e., one quarter of a wavelength of a 200 MHz frequency). In embodiments where relatively low frequencies are to be received, the conductive element 342 may be coiled or folded to reduce the length of the first antenna element 302 such that it can fit the length of the left cord 306.

In an alternative embodiment, the conductive shield 326 may function as the first antenna element. In this embodiment, the first antenna element 302 is not mounted to the left cord 306 and the passive conductors 340 and 344 are not needed. Instead, the conductive lead 322 is directly coupled to the conductor 334. In a further embodiment, the capacitor 210 (FIG. 2) is coupled to the conductor 206 (FIG. 2), thus allowing the RF signal received by the shield 326 to go through the conductor element 338 to the conductor 206 and through the capacitor 210 to provide RF_in 1.

Referring now to FIG. 3c, a detailed diagram of the right earpiece 312 assembly is shown. A conducting lead 328 is coupled to a right audio transducer 350 by a coupling passive component 352. In exemplary embodiments, the passive component 352 is an inductor. The passive component 352 allows transfer of the low frequency audio_R signal from the receiving device 102 through the conducting lead 328 to the transducer 350. The passive component 352 also prevents the high frequency RF signal from the second antenna element 304 (FIG. 3a) from transferring to a conducting lead 354. Thus, the passive component 352 prevents loss of power of the RF signal picked up by the second antenna element 304. In an alternative embodiment, the passive component 352 is omitted and the conducting lead 354 is an extension of the conductive (wire) lead 328.

The conductive lead 328 is further coupled to conductive element 356 of the second antenna element 304 via a coupling passive component 358. In exemplary embodiments, the passive component 358 is a capacitor. The passive component 358 allows transfer of the high RF signals obtained from the air by the conductive element 356 to the receiving device 102. The passive component 358 also prevents the low frequency audio_R signal from going to the conductive element 356. In a further embodiment, the passive component 358 also prevents low frequency signals passed over the air to interfere with the part of the signal that is desired (i.e., the high frequencies that we pick up) thereby possibly reducing noise. In an alternative embodiment, the passive component 358 is omitted and the conductive element 356 is an extension of the conductive wire lead 328.

In one embodiment, the second antenna element 304 is coupled to the support shaft 314 (FIG. 3a), and comprises the conductive element 356. In an embodiment where the support shaft 314 comprises insulating materials, the conductive element 356 may be embedded inside the support shaft 314. In an alternative embodiment, the conductive element 356 is embedded inside insulating material that is mounted or coupled to a length of the support shaft 314.

Similar to the conductive element 342, the conductive element 356 can be chosen to be one quarter of the wavelength of the RF signal of interest (i.e., the frequency carrying the received RF channel). In a case where a range of frequencies is of interest, the length of the conductive element 356 can be set to one quarter of the frequency which resides in a middle of the range. In an alternative embodiment, the conductive element 365 may be a multiple of a one quarter wavelength and still receive the desired signal. In embodiments where relatively low frequencies are to be received, the conductive element 356 may be coiled or folded to reduce the length of the second antenna element 304 such that it can fit along the length of the support shaft 314.

In alternative embodiments, the (second antenna) lead 356 may be coupled to any point on the right cord 308. In these embodiments, the passive component 358 may be coupled to the right cord 308 at the point of the connection between the lead 356 and the lead 328. The connection point between the lead 356 and the lead 328 is at a meeting point of the right cord 308 and the left cord 306, according to one embodiment. At this meeting point, an insulator material may be placed to mechanically hold the left cord 306, right cord 308, second antenna element 304, and passive component 358.

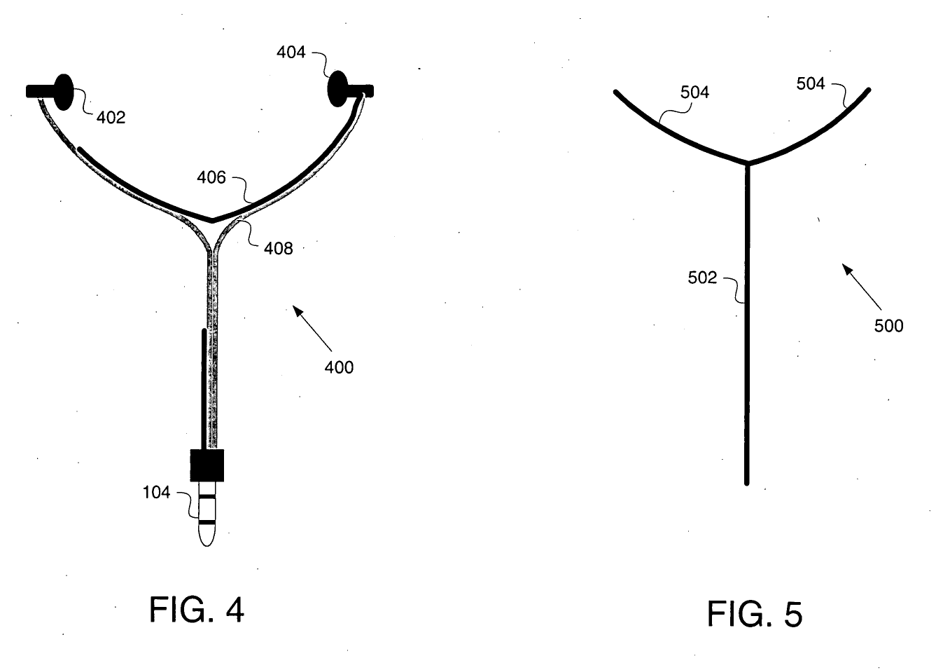

Referring now to FIG. 4, an alternative embodiment of a headset apparatus 400 is shown. In this embodiment, the headset apparatus 400 does not comprise a support shaft coupled between the earpieces 402 and 404. Instead, a second antenna element 406 is coupled to a cord or cords 408 that splits between the left earpiece 402 and the right earpiece 404. In this embodiment, a second antenna lead may be coupled to a lead at the right earpiece 404.

In further embodiments, leads and cords of the headset apparatus may be electrically optimized for use as an antenna element for various frequency bands of interest. In some embodiments, antenna gain is improved by impedance matching an antenna impedance to that of a receiver device input impedance. As a result, a much lower voltage standing wave ratio (VSWR) results having increased gain over desired frequency ranges.

While above embodiments describe headset apparatuses comprising two shielded wires (i.e., left and right cords) or two double thread insulated wires which carry audio signals to the earpieces, alternatively, at least one of the shielded wires may be used as a coaxial transmission RF line. Furthermore, by using radiating antenna elements (e.g., located at location of the split between the right and left cords), up to 15 dB polarization diversity in a 88-108 MHz frequency band may be obtained.

Referring now to FIG. 5, one such alternative embodiment is shown. The embodiment of FIG. 5 provides an equivalent circuit 500 to that of the antenna element 302 (FIG. 3a). In this embodiment, the circuit 500 is the shield of the cord, and comprises a center section 502 and top sections 504. The entire shield of the cord provides a radiating antenna element. In another embodiment, the circuit 500 is the ground lead of the cord which provides a radiating antenna element.

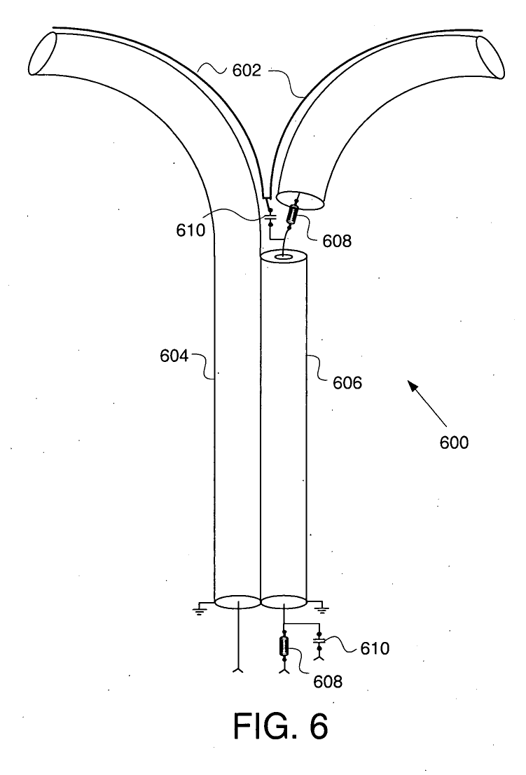

Referring now to FIG. 6, another embodiment of a headset apparatus 600 is shown. This embodiment comprises antenna elements 602 coupled to a left and right cord 604 and 606, respectively. In this embodiment, RF signals, which are carried by vertically polarized electromagnetic waves, are received by the antenna elements 602 which lie generally in a vertical plane. The exemplary antenna elements 602 may comprise a conductive element that is chosen to be one quarter of the wavelength of the RF signal of interest.

Passive components 608 is configured to allow low frequency audio signals to pass, while preventing high RF signals from passing. Conversely, passive components 610 allows transfer of the high RF signals obtained from the air to the receiving device 102, while preventing low frequency audio signals from passing. In exemplary embodiments, the passive components 608 are inductors and the passive components 610 are capacitors. Conductors within the left and right cords 604 and 606 may be short in length at a juncture of the left and right cords 604 and 606, and may be further shielded to minimize impact on the audio path.

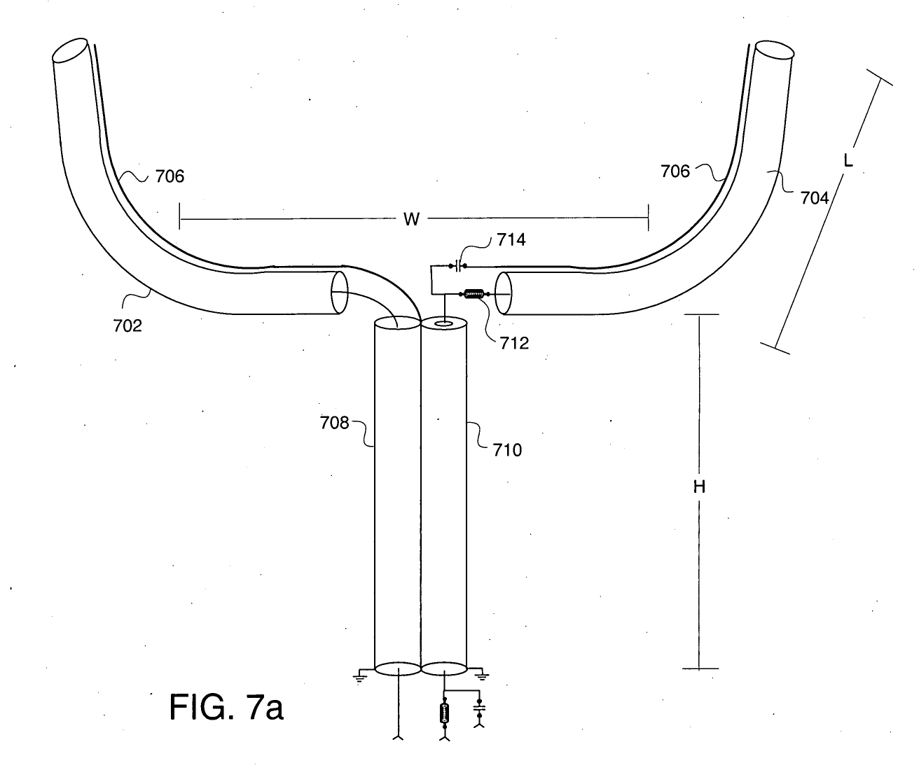

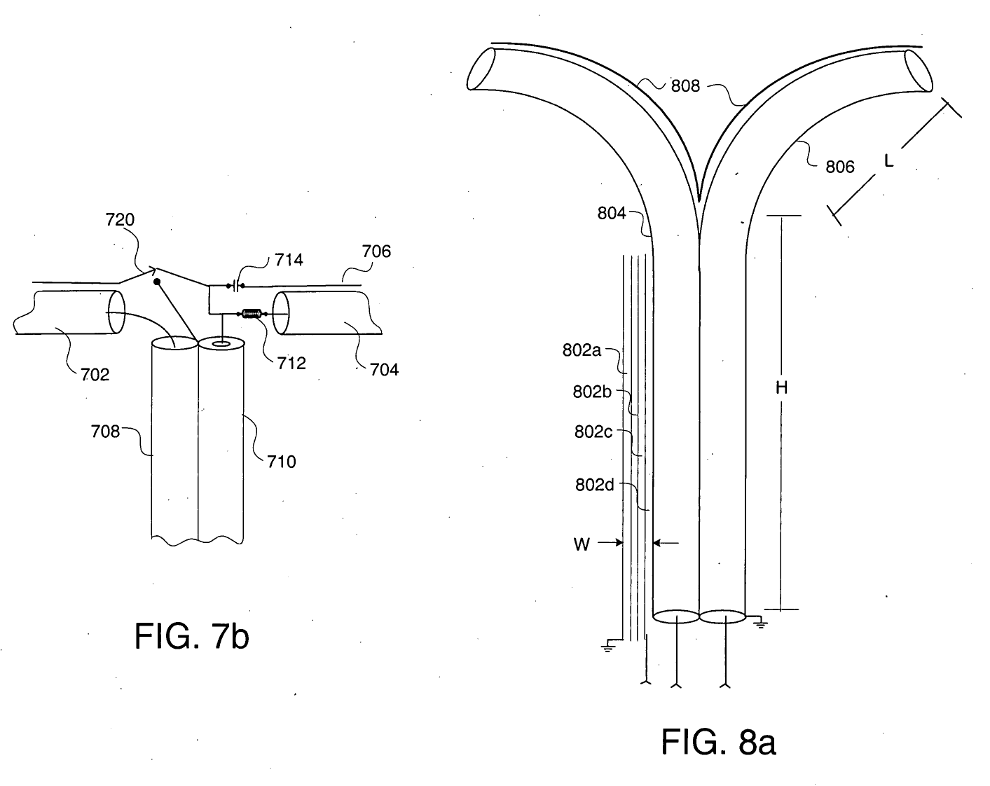

A further alternative embodiment of a headset apparatus 700 is shown in FIG. 7a. The headset apparatus 700 is similar to the headset apparatus 600. This embodiment differs from the previous embodiment in that upper left and right cords 702 and 704 are oriented generally in a horizontal plane along at least a part of a length of an antenna element 706. This orientation along with a dipole feed of the antenna elements 706 from cord 710 receives RF signals carried by electromagnetic waves having primarily horizontal polarization. In one example, the dimensions of the headset apparatus 700 may be H=7 in., W=6.7 in., and L=24 in.

As in previous embodiments, passive components 712 and 714 allow particular types of signals to pass by preventing other forms of signals from passing.

FIG. 7b illustrates a more detailed diagram of a juncture of the lower and upper cords 702, 704, 708, and 710. As shown, a single pole double throw RF switch 720 is provided to allow a selection of antenna configurations to respond to horizontally or vertically polarized electromagnetic waves. In the present embodiment, the RF switch 720 is shown in a vertical polarization position. In exemplary embodiments, polarization diversity up to 15 dB may be obtained over a 88-108 MHz FM frequency band utilizing this configuration.

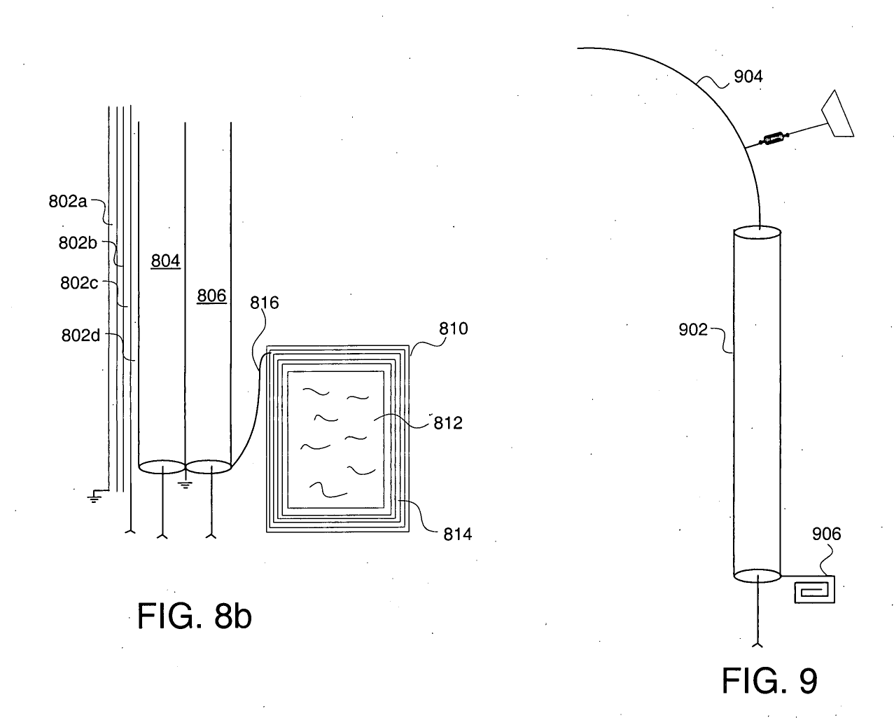

Referring now to FIG. 8a, another embodiment of a headset apparatus 800 is shown. This embodiment comprises a plurality of antenna elements 802a-802d physically coupled to a left cord 804. Alternatively, the antenna elements 802a-802d are physically coupled to a right cord 806. In exemplary embodiments, antenna element 802a is grounded, while the antenna element 802d is electrically coupled to a further antenna element 808. The antenna elements 802c and 802d are electrically coupled to the other antenna elements 802a, 802d, and 808. The combination of the antenna elements 802a-802d and 808 form an antenna system which provides RF signals to the receiving device (e.g., receiving device 102 of FIG. 1). The exemplary antenna system responds primarily to vertically polarized electromagnetic waves. In one example, dimensions of the headset apparatus 800 comprises H=18 in., L=12 in., and W=0.19 in.

Referring now to FIG. 8b, a portion of the embodiment of FIG. 8a is shown coupled to a printed wiring board (PWB) 810 or a receiver device. The PWB 810 comprises a central region 812 comprising wiring associated with the receiver device. The PWB 810 also comprises an isolated serpentine printed conductor 814, which may have a conductive element chosen to be one quarter of the wavelength of the RF signal of interest. The printed conductor 814 is coupled to the headset apparatus 800 via a conductor 816. In exemplary embodiments, the printed conductor 814 is configured to provide a non-radiating ground plane or counterpoise for the antenna system, thus creating a monopole antenna system. The exemplary printed conductor 814 may be printed around a periphery of the PWB 810, which provides an unbalanced monopole antenna system with better performance than a single non-resonant wire.

A further embodiment of a portion of a headset apparatus 900 is shown in FIG. 9. A cord 902 comprising a coaxial or two-wire transmission line is provided. The cords allows audio signals from a receiving device to be passed to earpieces while transmitting RF signals from an antenna element 904 to the receiving device. The exemplary antenna element 904 may be formed along a support shaft of the headset apparatus 900 (similar to the embodiment of FIG. 3). In this embodiment, a meander-line ground wire 906 is coupled to an outer shield or ground lead of the cord 902. A length of the ground wire 906 is selected to optimize a response of the antenna element 904 over a frequency of interest.

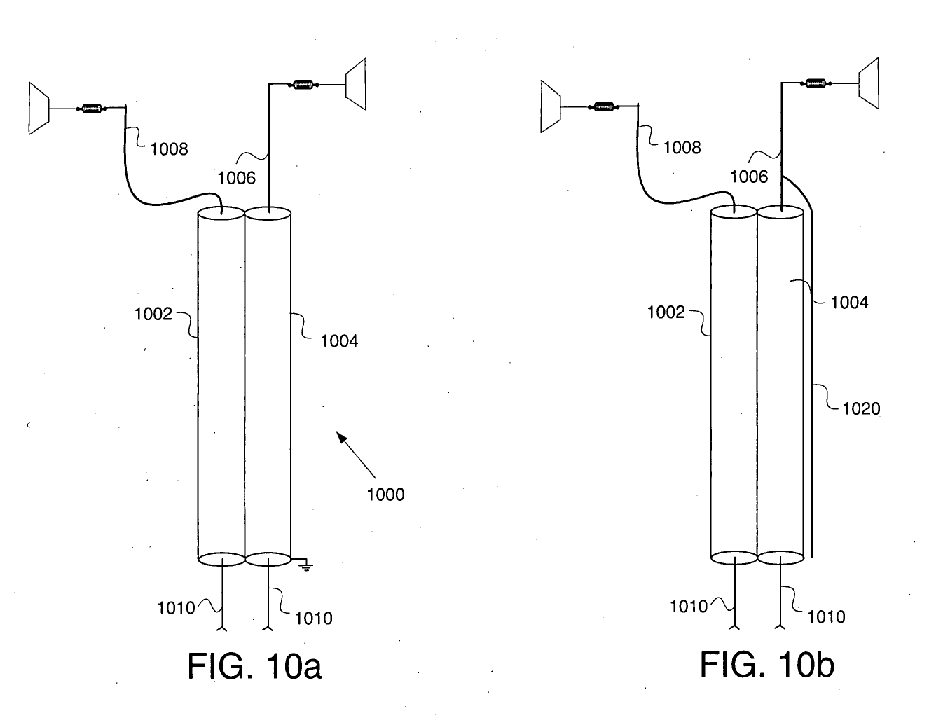

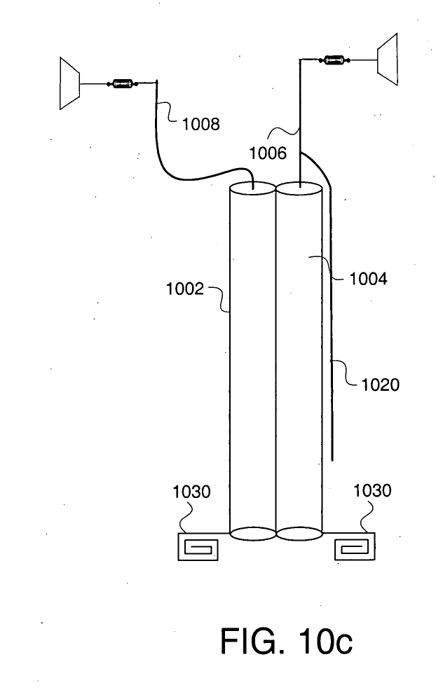

Further embodiments of a portion of a headset apparatus are shown in FIG. 10a-10c. In FIG. 10a, the headset apparatus 1000 comprises a left and right cord 1002 and 1004 which include transmission lines that transmits audio signals to earpieces. The headset apparatus 1000 also comprises antenna elements 1006 and 1008 coupled to a center conductor element of the left and right cords 1000 and 1002. These antenna elements 1006 and 1008 deliver RF signals to a receiving device via ports 1010. The antenna element 1006 responds primarily to vertically polarized electromagnetic waves while antenna element 1008 responds to both horizontally and vertically polarized electromagnetic waves.

The embodiment of FIG. 10b is similar to the embodiment of FIG. 10a with an exception of an additional radiating antenna element 1020. In one embodiment, the radiating antenna element 1020 is coupled to the right cord 1002. The radiating antenna element 1020 coupled with the antenna element 1006 to form a longer vertical antenna element.

Further, the embodiment of FIG. 10c is similar to the embodiment of FIG. 10b. The difference between the two embodiments is an addition of two meander-line ground wires 1030.

Although antenna elements that receive vertically polarized and horizontally polarized waves may be discussed herein, it will be understood by those skilled in the art that the antenna elements may also receive waves that are substantially or primarily vertically polarized electromagnetic waves and substantially or primarily horizontally polarized electromagnetic waves.

The present invention is described above with reference to exemplary embodiments. It will be apparent to those skilled in the art that various modifications may be made and other embodiments can be used without departing from the broader scope of the present invention. For example, the left and right cords in the various embodiments may be replaced with two conducting threads (in the location of the conductive leads), which may be isolated from each other by an insulating material. The conducting threads (i.e., conductive leads without shields) are coupled to the rest of the headset apparatus 100 in a similar manner as the coaxial cord implementation. Therefore, these and other variations upon the exemplary embodiments are intended to be covered by the present invention.

What is claimed is:

1. A system for improving radio reception comprising:
a headset apparatus comprising
a plurality of antenna elements configured to receive RF signals; and
a plug electrically coupled to the plurality of antenna elements and configured to forward the RF signals to a receiving device.

2. The system of claim 1 wherein at least one of the plurality of antenna elements is positioned vertically near the plug.

3. The system of claim 1 wherein one of the plurality of antenna elements is coupled to a headpiece of the headset apparatus.

4. The system of claim 1 wherein one of the plurality of antenna elements is coupled to a left cord and a right cord above a juncture of the left and right cords.

5. The system of claim 1 wherein at least one of the plurality of antenna elements is configured to respond to primarily vertically polarized electromagnetic waves.

6. The system of claim 1 wherein at least one of the plurality of antenna elements is configured to respond to primarily horizontally polarized electromagnetic waves.

7. The system of claim 1 wherein at least one of the plurality of antenna element is configured to respond to both primarily vertically and primarily horizontally polarized electromagnetic waves.

8. The system of claim 1 wherein the plurality of antenna elements are positioned in such a manner as to result in low-correlation between the plurality of antenna elements.

9. The system of claim 1 wherein the headset apparatus further comprises at least one meander-line ground wire.

10. The system of claim 1 wherein the headset apparatus further comprises at least one passive component configured to transfers low frequency audio signals while preventing transfer of high RF signals.

11. The system of claim 1 wherein the headset apparatus further comprises at least one passive component configured to transfer high RF signals while preventing transfer of low frequency audio signals.

12. The system of claim 1 wherein the plug comprises three conductors, a first conduct coupled to a first antenna element, a second conductor coupled to a second antenna element, and a third conductor coupled to a ground or a third antenna element.

13. The system of claim 1 wherein the plug is further configured to transfer left and right audio signals from the receiving device to a left earpiece and right earpiece of the headset apparatus.

14. The system of claim 1 wherein the plurality of antenna elements comprise a conduct element with a length chosen to be one quarter of a wavelength of a RF signal of interest.

15. The system of claim 1 further comprising the receiving device, the receiving device comprising a plurality of conductors which are configured to interface with a corresponding plurality of conductors in the plug.

16. The system of claim 15 wherein the receiving device comprises a RF tuner configured to generate intermediate frequency signals based on the RF signals received from the headset apparatus.

17. The system of claim 14 wherein the receiving device comprises a signal processing unit configured to product streams of data for output to a user.

18. A method for improving radio reception comprising:
receiving a first RF signal at a first antenna element of a headset apparatus;
receiving a second RF signal at a second antenna element of the headset apparatus;
forwarding the first and second RF signal to a receiving device for processing; and
receiving a left and right audio signal from the receiving device.

19. The method of claim 18 further comprising positioning the first and second antenna elements in such a manner as to result in a low-correlation between the first and second antenna elements.

20. A system for improving radio reception comprising:
a headset apparatus comprising a plurality of antenna elements configured to generate RF signals; and
a receiving device coupled to the headset apparatus and configured to receive the RF signals generated by the plurality of antenna elements.
